(19) United States
(12) Patent Application Publication
(10) Pub. No.: US 2022/0225665 A1
(43) Pub. Date: Jul. 21, 2022

(54) A Device and a Method for Improving Aerosol Generation in an Electronic Cigarette

(71) Applicant: JT International S.A., Geneva (CH)

(72) Inventor: Claude Zominy, Copponex (FR)

(73) Assignee: JT International S.A., Geneva (CH)

(21) Appl. No.: 17/605,151

(22) PCT Filed: Aug. 19, 2020
(86) PCT No.: PCT/EP2020/073268

§ 371 Date: Oct. 20, 2021

(30) Foreign Application Priority Data
Aug. 20, 2019 (EP) 19192624.5

(51) Int. Cl. A24F 40/10; A24F 40/50; A24F 40/42; A24F 40/65

(52) U.S. Cl. CPC A24F 40/10; A24F 40/65; A24F 40/42; A24F 40/50

(57) ABSTRACT

An aerosol generating device including a fluidic pathway that is in fluidic connection with a container holding an aerosol-forming liquid, a heating element that is in operative connection with the fluidic pathway, the heating element configured to heat the aerosol-forming liquid when inside the fluidic pathway to generate an aerosol, a power device for controlling power delivered to the heating element to control a heating power of the heating element, and a controller for controlling the power device to selectively make a first power delivery to the heating element to vaporize a portion of the aerosol-forming liquid to form a gas gap before making a second power delivery to the heating element, wherein the gas gap comprises an area of the fluidic pathway in contact with a heating surface of the heating element in which the aerosol-forming liquid has vaporised to form a gas, wherein the first power delivery is at a value below the second power delivery.

The present disclosure related generally to aerosol or vapor generating systems and devices, more particularly methods of controlling an aerosol or vapor generation with an aerosol-forming liquid which can be heated to produce an aerosol for inhalation by a user.

### BACKGROUND ART

The use of aerosol generating systems, also known as e-cigarettes, e-cigs (EC), electronic nicotine delivery systems (ENDS), electronic non-nicotine delivery systems (ENNDS), electronic smoking devices (ESDs), personal vaporizers (PV), inhalation devices, vapes, which can be used as an alternative to conventional smoking articles such as lit-end cigarettes, cigars, and pipes, is becoming increasingly popular and widespread. The most commonly used e-cigarettes are usually battery powered and use a resistance heating element to heat and atomize a liquid containing nicotine (also known as e-cigarette liquid, e-cig liquids, e-liquid, juice, vapor juice, smoke juice, e-juice, e-fluid, vape oil), to produce a nicotine-containing condensation aerosol (often called vapor) which can be inhaled by a user. The aerosol can be inhaled through a mouthpiece, which, in the case of aerosols formed from e-liquids which contain nicotine, can result in delivery of nicotine to the lungs, throat and mouth, etc. of the user, and aerosol exhaled by the user generally mimics the appearance of smoke from a conventional smoking article. Although inhalation of the aerosol creates a physical sensation which is similar to conventional smoking, harmful chemicals such as carbon monoxide and tar need not be produced or inhaled in any significant quantities compared to combustible smoking products because there is no combustion.

In the conventional e-cigarettes described above, the liquid is put into contact through small channels to a resistance heating element where it is heated and vaporized, for example via a wick having a plurality of small channels that transport the liquid from a reservoir to the heating element. However, with conventional e-cigarettes, small amounts of unwanted chemical compounds, for example but not limited to aldehydes such as formaldehyde, are produced during the volatisation process for reasons which are not yet fully understood but are believed to be a result of localized burning of the e-liquid on the metallic heating element, and some of these are eluted into the condensation aerosol for inhalation and then impact negatively on the organoleptic properties of the inhalation aerosol. Additionally, problems can then arise with continued use of the e-cigarette, because deposits can be formed on the surface of the resistance heating element due to this localized “burning” of the liquid. This can reduce the efficiency of the resistance heating element. Furthermore, when the deposits are subsequently heated during operation of the e-cigarette, they can evaporate to create an unpleasant taste and/or generate harmful components in the resulting vapor/aerosol. These problems can be addressed by replacing the resistance heating element or the e-cigarette itself before there is a significant build-up of such deposits, but this involves unwanted expense and inconvenience for the user. Accordingly, the background art present a number of deficiencies and problems, for example the unwanted build-up of deposits, and the present disclosure seeks to address these difficulties.

### SUMMARY

According to one aspect of the present invention, an aerosol generating device is provided. Preferably, the aerosol generating device includes a fluidic pathway that is in fluidic connection with a container holding an aerosol-forming liquid, a heating element that is in operative connection with the fluidic pathway, the heating element configured to heat the aerosol-forming liquid when inside the fluidic pathway to generate an aerosol, a power device for controlling power delivered to the heating element to control a heating power of the heating element, and a controller for controlling the power device to selectively make a first power delivery to the heating element to vaporize the aerosol-forming liquid before making a second power delivery to the heating element, wherein the first power delivery is at a value below the second power delivery. Preferably the controller is configured to control the power device to selectively make the first power delivery to the heating element to vaporize a portion of the aerosol-forming liquid to form a gas gap before making the second power delivery to the heating element, wherein the gas gap comprises an area of the fluidic pathway in contact with a heating surface of the heating element in which the aerosol-forming liquid has vaporised to form a gas.

Preferably the controller is configured to make the first power delivery at a beginning of an inhalation period by the user during a heater gas gap formation HGGF cycle, and after the HGGF cycle the controller is configured to make the second power delivery for a remaining time of the inhalation period. Preferably a duration of the HGGF cycle is configured to ascertain that a gas gap is formed in the fluidic pathway between the aerosol-forming liquid and a heating surface of the heating element. Preferably the HGGF cycle has a duration below 500 ms, or below 300 ms, or below 150 ms.

According to another aspect of the present invention, a method for controlling a power supply for an aerosol generating device is provided, wherein the aerosol generating device comprise a container, a fluidic pathway, a heating element in operative connection with the fluidic pathway, and a power device. Preferably, the method comprising the steps of detecting user inhalation of the aerosol generating device to determine an occurrence of an inhalation period, determining a power profile to be delivered to the heating element from the power device during the inhalation period, wherein the power profile defines selection of a first power delivery to the heating element to vaporize the aerosol-forming liquid before a second power delivery to the heating element, wherein the first power delivery is at a value below the second power delivery, and controlling the power device to make power delivery to the heating element based on the determined power profile. Preferably the power profile defines a selection of a first power delivery to the heating element to vaporize a portion of the aerosol-forming liquid to form a gas gap before a second power delivery to the heating element, wherein the gas gap comprises an area of the fluidic pathway in contact with a heating surface of the heating element in which the aerosol-forming liquid has vaporised to form a gas.

Preferably the first power delivery is made at a beginning of an inhalation period by the user during a heater gas gap formation HGGF cycle, and after the HGGF cycle the controller is configured to make the second power delivery for a remaining time of the inhalation period. Preferably a duration of the HGGF cycle is configured to ascertain that a gas gap is formed in the fluidic pathway between the aerosol-forming liquid and a heating surface of the heating element. Preferably the HGGF cycle has a duration below 500 ms, or below 300 ms, or below 150 ms.

According to still another aspect of the present invention, a cartridge for generating an aerosol is provided. Preferably, the cartridge includes a liquid container for holding an aerosol-forming liquid, a fluidic pathway that is in fluidic connection with the liquid container, a heating element that is in operative connection with the fluidic pathway, the heating element configured to heat the aerosol-forming liquid when inside the fluidic pathway to generate an aerosol, a memory storing data related to a power profile needed by the heating element to generate the aerosol, wherein the power profile defines selection of a first power delivery to the heating element to vaporize the aerosol-forming liquid before a second power delivery to the heating element, wherein the first power delivery is at a value below the second power delivery, and a controller for sending the data related to the power profile to an external device upon connection of the cartridge with the external device so that the external device can deliver power to the heating element of the cartridge based on the power profile. Preferably the power profile defines a selection of a first power delivery to the heating element to vaporize a portion of the aerosol-forming liquid to form a gas gap before a second power delivery to the heating element, wherein the gas gap comprises an area of the fluidic pathway in contact with a heating surface of the heating element in which the aerosol-forming liquid has vaporised to form a gas.

Preferably the first power delivery is made at a beginning of an inhalation period by the user during a heater gas gap formation HGGF cycle, and after the HGGF cycle the controller is configured to make the second power delivery for a remaining time of the inhalation period. Preferably a duration of the HGGF cycle is configured to ascertain that a gas gap is formed in the fluidic pathway between the aerosol-forming liquid and a heating surface of the heating element. Preferably the HGGF cycle has a duration below 500 ms, or below 300 ms, or below 150 ms.

The following configurations may additionally be provided.

Preferably, the gas gap can be considered as a separation between the aerosol forming liquid in the fluidic pathway and the heating surface of the heating element.

Preferably, the separation is defined by a region of the fluidic pathway adjacent to the heating surface in which the aerosol forming liquid has vaporised in the first power delivery.

Preferably, the separation is between substantially the entire heating surface and the fluidic pathway.

Preferably, the separation is formed by the generation of a gas by heating and vaporizing a portion of the aerosol forming liquid during the first power delivery, the portion inside the region of the fluidic pathway adjacent to the heating surface.

Preferably, the separation is configured to inhibit aerosol forming liquid in the fluidic pathway being in direct contact with the heating surface of the heating element during the second power delivery.

Preferably, the power device is configured to deliver power to the heating element during an inhalation period, the inhalation period comprising a pre-aerosol-delivery step and an aerosol-delivery step, and wherein the first power delivery is in the pre-aerosol-delivery step and the second power delivery is in the aerosol-delivery step. The inhalation period can also be referred to as a vaporization session.

Preferably, the pre-aerosol-delivery step is configured to vaporise the portion of the aerosol forming liquid inside the region of the fluidic pathway adjacent to the heating surface to create the gas gap before the aerosol-delivery step, and wherein the aerosol-delivery step is configured for a user to inhale the aerosol generated by the second power delivery.

Preferably, the pre-aerosol-delivery step is configured to take place before the user inhales upon the aerosol generating device. The pre-aerosol delivery step can be initiated by the user pressing a button to trigger the inhalation period.

Alternatively, the pre-aerosol-delivery step is configured to take place as the user begins to inhale upon the aerosol generating device. The pre-aerosol-delivery step can be initiated by a puff sensor that, for example, detects a pressure change when the user inhales upon the aerosol generating device to trigger the inhalation period.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 shows an exemplary schematic view of the aerosol generating device 100 having a heating element 30 for generating an aerosol 40 via a fluidic device 20 according to an aspect of the present invention;

FIG. 2 schematically and exemplarily shows an embodiment of the aerosol generating device 200 having a capillary wick 120 as the fluidic device, and a heating coil 130 wrapped around the capillary wick 120 for generating the aerosol 140;

FIGS. 3A-3C illustrate problems related to the conventional way of heating for generating an aerosol, with FIG. 3A showing a side view and FIG. 3B showing a cross-sectional view of a heating device 30 and the fluidic device 20, in the variant of a heating coil 130 and capillary wick 120, and FIG. 3C showing a timely evaluation of a graph representing a temperature inside the fluidic device or at a surface of heating device 30 showing an excess temperature that leads to a burn zone BZ;

FIGS. 4A-4D show aspects of the solution to the problem related to the generation of burned solid particles, with FIG. 4A showing a timely evaluation of a graph representing a temperature inside the fluidic device or at a surface of heating device 30, FIGS. 4B and 4C showing a cross-sectional views of a heating device 30 and the fluidic device 20 where a gas gap GG is present, in the variant of a heating coil 130 and capillary wick 120, and FIG. 4D showing two graphs representing the application of different heating phases, including the heater gas gap formation cycle HGGF and the normal heating cycle NHC;

FIGS. 5A-5D show different schematic and exemplary views of embodiments for the heating control device to establish the HGGF and NHC cycles with an aerosol generating device 100;

FIG. 6 shows an exemplary and schematic representation of an aerosol generating system, including a cartridge 400 that can be removably connected to a holder 500, the cartridge 400 including a memory 471 for storing data on characteristics of cartridge, for example data that parametrizes the HGGF and/or the NHC cycles for the specific cartridge 400; and

FIG. 7 exemplarily shows two curves showing a timely evolution of a temperature of the heating device 30, 130, and a heating power that is applied to heating device 30, 130, to show a relationship between the power level of heating device and the temperature.

Herein, identical reference numerals are used, where possible, to designate identical elements that are common to the figures. Also, the images are simplified for illustration purposes and may not be depicted to scale.

### DETAILED DESCRIPTION OF THE SEVERAL EMBODIMENTS

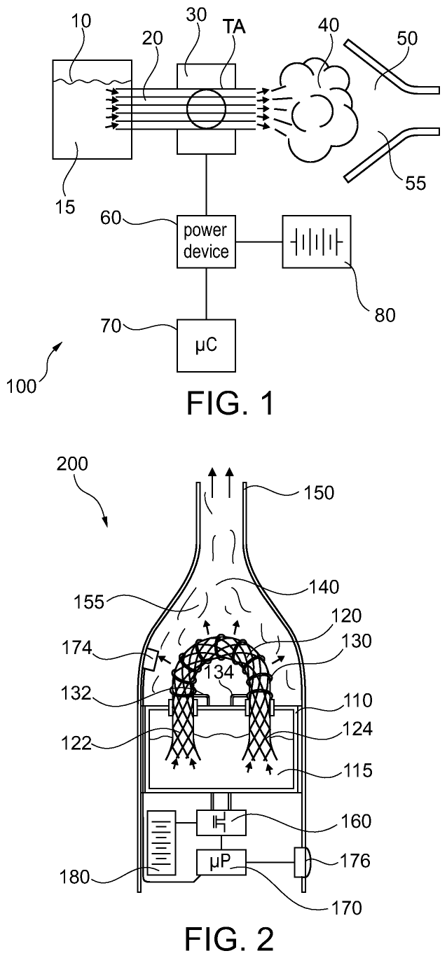

FIG. 1 depicts an exemplary schematic view of the aerosol generating system or device 100 with different elements in a symbolic representation, aerosol generating device 100 having a heating element 30 for generating an aerosol 40 via a fluidic element 20 according to an aspect of the present invention. An aerosol generating liquid 15 can be provided by a reservoir 10, reservoir 10 being in fluidic connection with a fluidic element 20 to bring the aerosol generating liquid 15 to a transformation area TA of the fluidic element 20 where the aerosol generating liquid 15 can be transformed to an aerosol 40 by heating and vaporizing with heating element 30. Fluidic element 20 can be a microfluidic device that has fluidic channels in a size and dimension that creates capillary motion or action on aerosol generating liquid 15, so that the liquid 15 will move from reservoir 10 towards transformation area TA. In another variant, it is possible that reservoir 10 is a container that is under pressure to generate a motion of liquid 15 towards transformation area TA. A yet further variant provides a dosing mechanism for transferring a dose of liquid 15 from the reservoir to the transformation area for example by using a bubble jet ejection mechanism or a mechanical liquid transfer element, or other suitable mechanisms. Heating device 30 is in operative connection with a power device 60 that allows to change a heating power that is generated by heating device 30, for example but not limited to a power switch or a power converter, and power device 60 is itself in operative connection with a controller 70, for example but not limited to a microcontroller, microprocessor, data processor, electronic circuit, that allows to control the power device 60 to control heating device 30, so that controller 70 can control power delivery to heating device 30, and therefore a heating power generated by heating device 30. A power storage device 80, for example a rechargeable battery, is supplying electric power to power device 60 for providing the heating power.

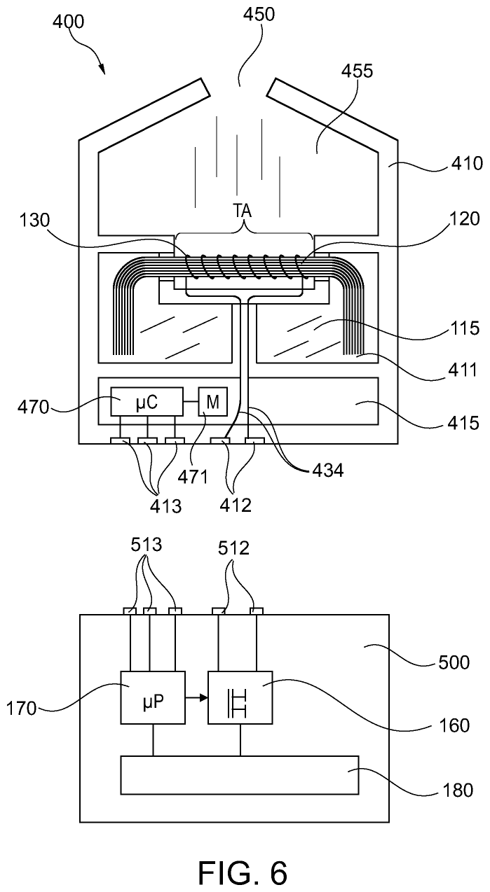

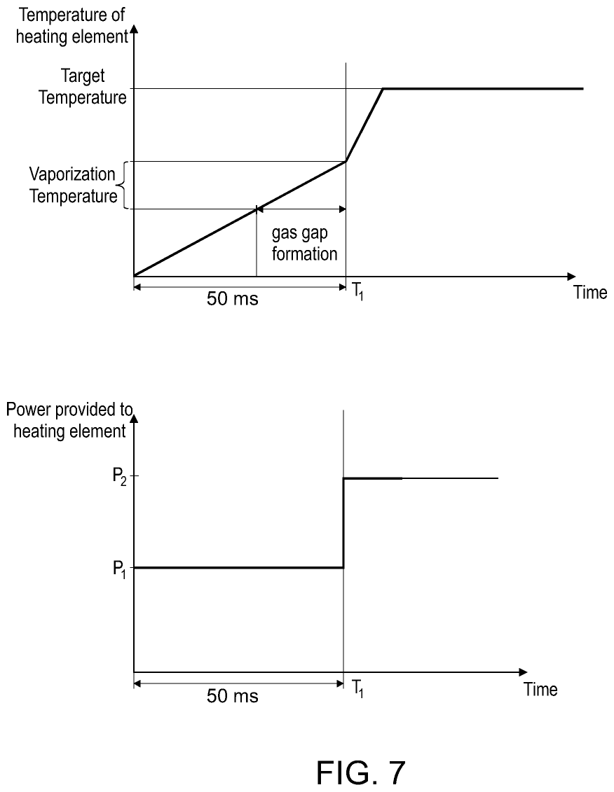

With the heating of fluidic element 20 by heating element 30, aerosol generating liquid 15 that enters by ingress ports of fluidic element 20 passes into or through transformation area TA of heating element 30, for example by capillary action, and will be transformed into an aerosol 40 by vaporization at a boiling point, so that aerosol 40 egresses from egress ports of fluidic element 20. Aerosol 40 is thereafter located in a vapor chamber 55 in proximity, in fluidic connection or at the mouthpiece 50, before exiting the mouthpiece 44 to enter a mouth of a user. Reservoir 10 can be part of a removable cartridge (see FIG. 6) or pod, that can be removably introduced to the e-cigarette.

FIG. 2 shows another exemplary schematic view of the aerosol generating device 200. In the embodiment shown in FIG. 2, heating element 30 is formed by a heating coil 130 as a wire that is wound around a fluidic element 20, in the variant shown a wick 120 forming a plurality of capillary fluidic channels. Other variants of the heating element 30 can be but are not limited to a resistive heating coil, an inductive heating coil, a heating plate, a capillary heating tube. Each end 122, 124 of wick 120 is arranged to be placed into or in fluidic connection with aerosol generating liquid 115, for example directly with a fluid reservoir 110 or container, or indirectly by fluidic connections, so that wick 120 will be filled or otherwise provided with aerosol generating liquid 115. This can be done by capillary action resulting from the dimensions and arrangement of the fluidic channels provided by wick 120, to pull liquid 115 into wick 120 as indicated by the arrows in liquid 115 of FIG. 2. Wick 120 can be made of a bundle of fibers, bundle of hollow or porous tubes, or made of a porous solid, for example a ceramic material, or other fluidic device that allows to transport the aerosol generating liquid 115 from reservoir 120 to a transformation area TA where the wick 120 can be heated by heating coil 130, for example with microchannels. Heating coil 130 is wound around wick 120 to form transformation area TA, where a surface of the wires that form heating coil 130 are in contact with wick 120, such that wick 120 can be sufficiently heated to vaporize aerosol generating liquid 115 to generate aerosol 140 that will egress from wick 120 as indicated by the arrows pointing away from which 120 into vapor chamber 155 that is in fluidic connection with mouthpiece 150.

Heating coil 130 is electrically connected by connection wires 132, 134 to a power device 160, for example but not limited to a switch, a plurality of switches, a resistor different types of DC-DC converters such as a buck converter or a boost converter, or a combination thereof, or different types of current converters to control a current delivered to heating device 30, 130, arranged to limit or control the power delivered to heating device 130, and a power storage device 180, for example a battery, that provides electric power to power device 160. In this variant, the heating is performed by the resistivity of the conductive material that forms heating coil 130, and by providing a certain voltage to connection wires 132, 132 with power device 160, based on the resistivity of heating coil, a heating power is generated. Moreover, power device 160 can be controlled by a controller 170, for example but not limited to a microprocessor, data processor, microcontroller, or other type of controller device, so that a power that is provided from power storage device 180 via power device 160 to heating coil 130 can be controlled based on data processing and of the controller 170. A more detailed version of this embodiment of the aerosol generating device 200 as discussed in FIG. 2 is shown in U.S. Patent Publication No. 2019/0046745 showing an exemplary heating coil 450 around a wick 440, 1440, with its ends located in a chamber 270 containing a reservoir of liquid, the aerosol generating liquid 115, this reference herewith incorporated by reference in its entirety. Another more detailed version of this embodiment can be seen in PCT publication with the Serial Number WO2017/176111, this reference herewith also incorporated by reference in its entirety, showing a wick 6, a heating member 7, fluid reservoir 8, and liquid outlets 9A, 9B in fluidic connection with ends of wick 6.

With certain heating coils 130 their relative thin diameter can be problematic, causing so-called hot spots along the heating wire that forms the heating coil 130. Vaporization by heating device 30, for example by heating coil 130 works well when heating coil 130 is made of a relatively thin wire to obtain a high power density, to create high heating power concentrated to a relatively small area. However, if the heating wires are too thin, other problems may arise. For example, the wire can become mechanically too fragile, thereby making it hard to safely and efficiently assemble the coil wick structure of heating coil 130, and making it prone to failure due to tearing. Also, the reduced cross-sectional area will lead to less electric conductivity, and at sections with reduced cross-sectional area, for example pinch points or bends, the relative reduction of the cross-sectional area of a thinner wire will be much larger as compared to a wire with a larger cross-sectional area, leading to the generation of significant hot spots along the heating coil 130, which are spots with a much higher temperature as compared to the average temperature of the wire that forms the heating coil 130. Such hot spots are undesirable, as they can establish non-uniform heating of the transformation area TA of wick 120, and this in turn can create heating temperatures that exceed a nominal or safe value. This in turn can create carbonyls from aerosol generating liquid 115, which will adversely impact the taste of the inhalable aerosol 140, and raising health issues. Furthermore in extreme cases, the excess temperatures of the thin spots can cause the wire of heating coil 130 to melt and break at those points if the wire is very thin. For heating coil 130, wires are therefore chosen to have a diameter in a range between about 0.1 mm to 0.3 mm.

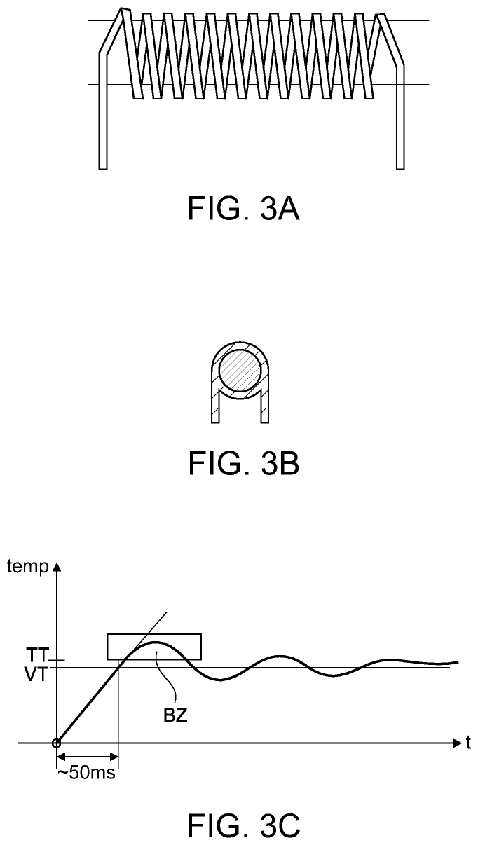

A specific problem with heating devices 30 and fluidic elements 20 associated therewith, for example with heating coil 130 having a transformation area TA that is exemplarily defined between the windings of the coil, with a wick 120 as the fluidic element 20, for example wick 120, located between the heating coil 130, is illustrated with FIG. 3A and the cross-sectional view of FIG. 3B, and the graph illustrated in FIG. 3C showing the evolution of the temperature at the heating coil 130. Generally, transformation area TA can be at one or more locations in the vicinity of areas where the heating coil 130 is in contact with wick 120. Usually, when electric power is delivered to the heating device 30 in an on/off fashion, either there is no electric power delivered to heating device 30, 130, or a nominal power is delivered from a power source, for example battery 180, to heating device 30, 130. This causes a relatively rapid and strong heating of fluidic element 20, 120 by heating device 30, 130, usually at a specific nominal power. With such an approach, which is relatively common amongst fairly simple e-cigarettes, when heating up the heating device 30, 130, the heating temperature T of the heating coil will rapidly approach and then largely maintain a consistent operating temperature at which vaporization is ample. At this operating temperature, any fluctuations in the power applied to the heating coil tend to result in corresponding fluctuations in the amount of vaporization occurring rather than in (significant) variations in the (average) temperature of the heating coil since most of the heat energy from the heating coil is used to supply the latent heat of vaporization of the e-liquid necessary for it to vaporize.

More sophisticated heating coil temperature control schemes may be employed in more sophisticated e-cigarettes. For example, some e-cigarettes employ a Proportional Integral Derivative (PID), or sometimes, by setting the Integral component to 0, a Proportional Derivative (PD), negative feedback loop temperature control system to accurately maintain the (average) temperature of the coil at a desired target temperature. Such e-cigarettes typically employ a metallic heating coil made of a metal such as stainless steel or titanium which have a non-negligible temperature coefficient of resistivity such that the average temperature of the heating coil can be estimated based on a measurement of the resistance of the heating coil. As is well known, control systems operating on a negative feedback temperature control system typically overshoot the target temperature, for example the vaporization temperature VT of liquid 15, 115, especially where the ramp up time is short. This temperature overshoot of the desired temperature VT is a result of heating device 30, 130 trying to ramp up the temperature as fast as possible. This leads to a temperature overshoot over a specific threshold temperature TT within the fluidic element 20, 120 to which the liquid 15, 115 is exposed, and will cause an overheating of liquid 15, 115, labelled in FIG. 3C, in a burn zone BZ. The overheating of aerosol generating liquid 15, 115 beyond threshold temperature TT in this burn zone BZ can additionally create the decomposition of aerosol generating liquid 15, 115, to burn liquid 15, 115 creating burnt or decomposed material or solid residual particles, instead of properly vaporizing liquid 15, 115, in addition to that which may be caused simply by virtue of the rapid temperature rise prior to and during the formation of the gas gap. Moreover, the accumulation of burnt or decomposed material in proximity of a heating surface of heating coil 130 can create a deposition of this material onto the heating surface, and can participate in the generation of additional carbonyls in the aerosol 40, 140. Also, this can lead to oxidation of the coil of heating device 30, 130, deteriorating device performance and life time duration.

For aerosol generating devices having a close-loop (negative feedback loop) temperature control system to avoid overheating of heating device 30, 130, and to avoid the decomposition of the liquid 15, 115, the temperature control system typically acts on the voltage Vout that is provided to heating device 30, 130. Usually the time constant as a response time or cycle time of a temperature control system is in the 100 ms to 150 ms range, which means that once a temperature error occurs, it will take some time above 100 ms to control the temperature to the correct desired temperature. Unfortunately, this control cycle and its time constant is too slow as compared to the fast ramp-up of the temperature to reach VT, and will not be able to prevent a temperature overshoot to pass over threshold temperature TT, and the resulting establishment of the burn zone BZ. Moreover, even if the temperature control system has a faster response time or cycle time, such PID close-loop control systems are typically arranged to control the system to rapidly approach and then maintain a target temperature, but are less suited to achieving a specified ramp-up profile. In other words, they “try” to ramp up the controlled variable (i.e. in this case the measured temperature of the heating coil) as quickly as possible. In addition, for many aerosol generating devices 100, especially during ramp up when the system has not yet reached a steady state, the relationship between the heating coil temperature and the temperature of e-liquid which is being vaporised may be complex and unpredictable meaning that the temperature of the heating coil may not be a useful measure of the temperature of the e-liquid being heated, which leads also to additional difficulties to properly control the temperature of the e-liquid close to the heating coil when simply relying on a close-loop control system based on heater coil temperature, especially during the critical ramp-up phase.

Moreover, even in the event that a control scheme is employed which prevents the occurrence of hot spots or temperature overshoots beyond the desired target temperature during temperature ramp up, it is believed that there may also be problems associated with on overly fast ramp up of temperature for reasons explained below. In particular, and without wishing to be overly bound by theory, until a steady state vaporization state is reached, liquid may be in direct contact with a heating element, and at a temperature which is sufficient to burn the liquid whilst it is in direct contact with the heating element, even when that temperature is not such as to burn the liquid when it is protected by a vapour gap, and, indeed, even when that same temperature is an optimum or good temperature for vaporizing the liquid when such a vapor gap has been established.

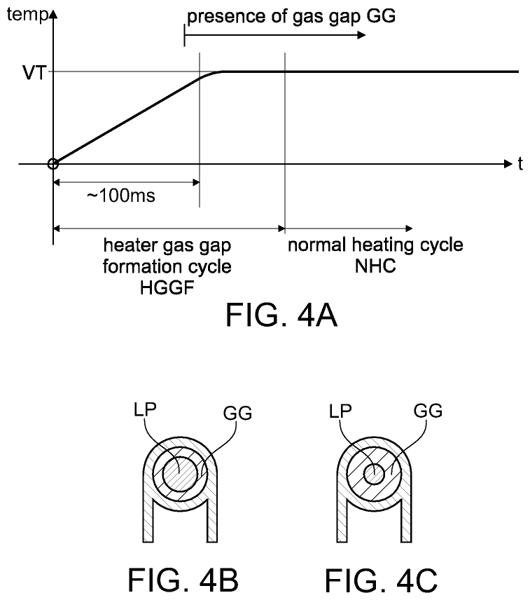

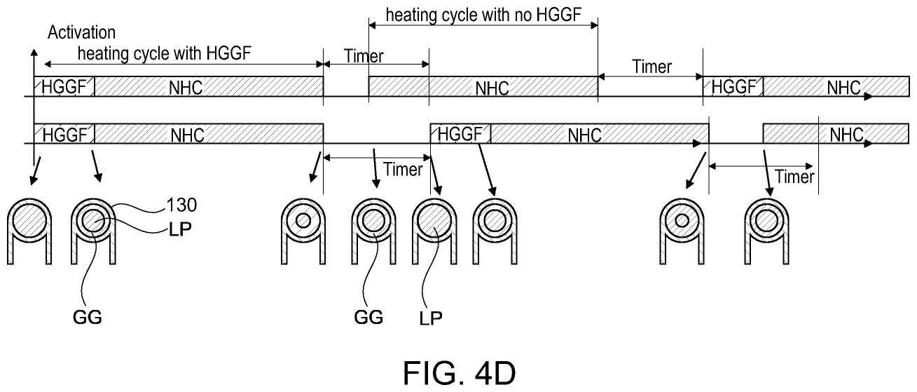

A solution to this problem is herein proposed, by the use of the proposed device, system and method, where a heater gas gap formation cycle or period HGGF is used, in which the heating device 30, 130, when initiating the heating phase HP, is first heated with a reduced amount of power, as compared to the nominal heating power, to somewhat increase the ramp-up time, but at the same time avoiding or substantially reducing undesirable chemical formation during the ramp up phase, as illustrated in FIG. 4A. The HGGF period is preferably designed such that there is sufficient time for all e-liquid directly contacting the heating coil to vaporize away from the surface of the heating coil 130 before reaching a temperature at which chemical reactions could occur resulting in the formation of undesirable complex chemicals such as aldehydes and carbonyls etc. Once the heater gas gap has been formed it is considered safe for the heating coil temperature to rise above the temperature at which the gas gap forms since in this case there is no e-liquid directly touching the hot heating coil any more and rather e-liquid is vaporized in a non-burning manner prior to touching the heating coil. Thereafter, the heating device 30, 130 can thus be operated at nominal heating power in the normal heating cycle NHC. This strategy can substantially reduce or even eliminate the formation of undesirable complex chemicals such as aldehydes, carbonyls etc. that are generated when using conventional heating strategies. This can substantially reduce the creation of the carbonyls in the inhalable condensation aerosol produced and can also reduce oxidation of the coil of heating device 30, 130, increasing the lifetime of heating device 30, 130.

Usually, when electric power is delivered to the heating device 30, 130, areas of the fluidic element 20, 120 in close proximity to a heating surface of heating device 30, 130 receive more heating power than areas of the fluidic element 20, 120 that are more remote to a heating surface of heating device 30. In other words, there is a delay of the heating between areas close to heating device 30, 130 in fluidic element 20, 120, as compared to areas that are more remote to heating device 30, 130. This is due to thermal capacity and thermal insulation provided by fluidic element 20, 120, and also a propagation time provided by the fluidic element 20, 120 for distributing or otherwise providing aerosol generating liquid 15, 115, therein, for example by soaking the wick 120 with the aerosol generating liquid 15.

This effect results in the reaching of a vaporizing temperature VT of aerosol generating liquid 15, 115 within the fluidic element 20, 120 at a first time t1 for areas close to a heating surface of heating device 30, 130 that is in operative engagement with fluidic element 20, 120, while reaching a vaporizing temperature VT of aerosol generating liquid 15, 115 at a second, later time t2 for areas farther to the heating surface of heating device 30, 130. As a result, aerosol generating liquid 15, 115 is vaporized selectively at areas that are closer to heating device 30, 130, leading to areas within the body of fluidic element 20, 120 where aerosol generating liquid 15, 115 is vaporized and is present in gas form, as vapor 40, 140. FIG. 3B shows a cross-sectional view of heating coil 130 and wick 120 where wick is entirely soaked through with aerosol generating liquid 15, 115, for example the one shown with a side view in FIG. 3A, prior to and thereafter, in FIG. 4B, a certain first time period after the heating by heating coil 130 has been activated or turned on, it is shown that only an inner core of wick 120 is soaked with aerosol generating liquid 15, 115, while an annular region with a certain close distance or radius to a surface of heating coil 130 does not have any liquid anymore due to vaporization of the adjacent e-liquid.

Instead, the region or volume contains the aerosol generating liquid 15, 115 in gas form, being vapor 40, 140, illustrated by a lighter shading of the cross-sectional view, to form a so-called gas gap GG between heater and liquid-drenched or liquid-containing fluidic element 20, 120. Next, as exemplarily shown in FIG. 4C, a certain second time period after the first time period, while heating by heating coil 130 is still active during the ramp-up phase, even a smaller circle of the inner core of wick 120 is soaked with aerosol generating liquid 15, 115, due to a vaporizing temperature VT reaching a more remote area to heating coil 130. At this stage the gas gap GG has been fully formed and the system reaches a more steady state of operation.

This effect is influenced by a slower heat transfer of the heat inside gas, e.g. gas gap GG, formed by evaporated liquid as compared to the heat transfer provided by liquid 15, 115, such that once a surface area of fluidic element 20, 120 in contact with a heating surface of heater device 30, 130 is devoid of aerosol generating liquid 15, 115 and has transformed to gas 40, 140 by evaporation to form gas gap GG, the heat transfer is further diminished. This phenomenon is comparable or similar to the Leidenfrost effect, being a physical phenomenon in which a liquid, for example liquid 15, 115, close to a heating mass, in this case a surface of heater device 30, 130 that is significantly hotter than the vaporization temperature of the liquid 15, 115, produces an insulating vapor layer that keeps the liquid 15, 115 from boiling or vaporizing rapidly. This establishes a repulsive force that suspends the remaining liquid 15, 115 away from the heating mass against gravity, for example to a droplet, preventing any further direct contact between the liquid 15, 115 and the heater device 30, 130. In the present situation, the gravity effect can be compared to the capillary suction effect of fluidic element 20, 120, for example by the wick, that acts against a pressure build up by the gas gap GG or gas layer.

Simultaneously, aerosol generating liquid 15, 115 is passively redistributed within the body of fluidic element 20, 120, for example by capillary action, soaking, or refilling within wick, and cannot replenish the areas or volumes that are devoid of aerosol generating liquid 15, 115 fast enough to provide continuity of the presence of aerosol generating liquid 15, 115 throughout fluidic element 20, 120, especially when heated at nominal power. Generally, when the heater device 30, 130 is being provided nominal heating power, a time required to evaporate a certain area or volume by evaporation of fluidic element 20, 120 to form the gas gap GG is much shorter than a time required to replenish the same area or volume by capillary action with fluidic element 20, 120.

The controlling of the heating power by the two cycles, first the heater gas gap formation cycle HGGF and the thereafter the normal heating cycle NHC take advantage of the effect that is provided by the gas gap GG. A duration of the HGGF is designed such that the gas gap GG is established before the heater is switched to the more powerful normal heating cycle NHC, to avoid e-liquid in contact with the heating coil from being heated to temperatures above the vaporization temperature at which complex chemical reactions can occur resulting in the generation of unwanted chemicals before the gas gap GG is formed. It will be appreciated that at the boundary between the liquid layer and the gas gap the temperature may be significantly lower than at the heating coil surface. In fact, the temperature at the interface between liquid and gas/vapour will of course be the vaporization temperature of the e-liquid and a non-flat interface can be neatly accommodated with little risk of e-liquid in the liquid phase touching the heating coil surface. This is believed to further mitigate against the formation of undesirable chemicals etc. In this respect, heating device 30, 130 is controlled to operate on a two-phase or two-cycle system. With this two-phase operation, heater gas gap formation cycle HGGF is selectively performed to make sure the gas gap GG is established inside the fluidic element 20, 120, where liquid 15, 115 will form a gas phase by gas gap GG and a liquid phase LP. Thereafter, the normal heating cycle NHC is performed, to take advantage of the insulating effect of the gas gap GG, so that the threshold temperature TT does not reach the liquid phase LP in the fluidic element 20, 120. In this respect, even if a heating surface of heating device 30, 130 is above the threshold temperature TT, due to the thermal insulation effect of the gas gap GG, based on the Leidenfrost effect, a temperature at the liquid phase LP will be below the threshold temperature TT, but still above the vaporization temperature VT.

Accordingly, with the above discussed control principles using a first power delivery to the heating element to vaporize the aerosol-forming liquid before making a second power delivery to the heating element, the first power delivery is at a value below the second power delivery, one goal is to limit or eliminate the generation of degraded by-products of aerosol generating liquid 15, 115 by avoiding to burn molecules of aerosol generating liquid 15, 115 during the heating phase. In addition, it is also a goal to provide for a controlled heating of heating device 30, 130, such that during a first cycle of the heating phase, being a heater gas gap formation cycle HGGF, a gas gap GG is formed inside fluidic element 20, 120, before a second heating phase is initiated in which a higher heating power is used, during a normal heating cycle NHC. Preferably, the gas gap GG established in the fluidic element 20, 120 is such that no liquid 15, 115 is in direct contact with any surface of the heating device 30, 130, as a partial contact of liquid 15, 115 with surfaces of heating device 30, 130 in the transformation zone TZ could lead to the creation of solid burnt or decomposed elements, the undesired by-product. This approach of first heating with a lower heating power for the temperature ramp-up in the heater gas gap formation cycle HGGF as compared to the higher heating power used in the subsequent normal heating cycle NHC is counter-intuitive and somewhat surprising in this field, as in the state of the art, the heaters are heated first with a larger power to provide for a very fast ready time of the device.

According to an aspect, a device, system, or method is provided, where the heating cycle of aerosol generating liquid 15, 115 by heating device 20, 120 is split into two temporal stages or cycles, instead of using a simple on/off heating at nominal heating power and an optional temperature control during the entire heating cycle. First, with a first heating cycle, a heater gas gap formation cycle HGGF is performed that establishes a gas gap GG in the fluidic element 20, 120, and thereafter, once the gas gap GG is present, a second heating cycle NHC is performed, at a higher heating power than the HGGF. The HGGF cycle can have a duration that is below 500 ms, preferably below 300 ms, or more preferably below 150 ms, and can start with the user taking a puff or making an inhalation, while the heating device 20, 120 is still cold.

FIG. 4C shows another aspect, in which different heating cycles are shown, four (4) of them having a first HGGF cycle, and two (2) having no HGGF cycle. If a second subsequent heating cycle HC2 is started within a certain time period TP of an end time of a first heating cycle HC2, it may not be necessary to start the second heating cycle HC2 with a HGGF. This is shown in the upper graph representation of FIG. 4C, where a heating cycle HC2 with no HGGF follows a first heating cycle HC1. This is due to the fact that the fluidic element 20, 120 and its capillary channels did not have enough time to be fully filled and soaked liquid 15, 115 in which case the liquid phase LP is again in contact with a surface of heating device 30, 130 after the first heating cycle HC1 where the gas gap GG was formed. This means that before a certain time period (a threshold idle time TIT which is sufficiently long enough to cool down the heater and also the vaporized gas such that the gas gap GG can be completely eliminated) is over, the next heating cycle HC2 is started, and the gas gap GG (already formed in first heating cycle HC1) will still be present in the fluidic element 20, 120 as illustrated in FIG. 4C, and hence there is no need to create a new gas gap GG. This means next heating cycle HC 2 can directly be started with the normal heating cycle NHC. Exemplarily, the TIT can be 1 second or more, depending on the characteristics of the fluidic element 20, 120, for example material used, porosity, diameter, and also depending on characteristics of the heating element 30, 130.

In contrast, as shown in the lower graph representation of FIG. 4C, a fourth heating cycle HC4 is started after a certain time period has revolved that is longer than the threshold idle time TIT, after an end of the third heating cycle HC3, so that the gas gap GG does not exist anymore, which means that fluidic element 20, 120 have had the time to be fully filled with liquid 15, 115 again. In such case, fourth heating cycle HC4 needs to be started with a heater gas gap formation cycle HGGF to re-establish the gas gap GG in the fluidic element 20, 120, to avoid excessive temperatures over the TT temperate in the heating coil which is very likely to cause chemical reaction forming undesired chemical compounds.

The timing of the heating cycles can be controlled by a timer that is programmed to controller 70, with a timing counter that counts a time revolved after an end of precedent heating cycle, so that upon staring of a new heating cycle, for example by detecting the user taking a puff or inhaling, it can be verified whether the threshold idle time TIT has been revolved, to see if a heater gas gap formation cycle HGGF is necessary. The end and the beginning of the heating cycle, whether with or without the HGGF, can be determined by a puff sensor 174 that can automatically provide a signal to controller 170 when a puff is made by user via mouthpiece 150, or can also be determined by the user manually pressing a button 176 that provides a signal to controller 170. The threshold idle time TIT can be a constant, but can also be calculated based on different parameters measured from aerosol generating device 100, for example but not limited to a duration of the preceding heating cycle, an average temperature caused by the heating device 30, 130, a fill level of the aerosol generating liquid 15, 115 in container 10, 110, an average heating energy consumed by the preceding heating cycle.

With respect to the difference between the first heating power and the second heating power, and their absolute values, these values are determined based on the materials, dimensions, and characteristics of aerosol generating device 100. Generally speaking, in terms of absolute value of heating power, the first heating power needs to be lower than the second heating power, but still above a certain absolute power threshold to have sufficient power to vaporize the liquid 15, 115 within a relatively short amount of time, this time being the HGGF cycle and, the HGGF cycle preferably being less than 500 ms, preferably below 300 ms, or more preferably below 150 ms. In this respect, the HGGF cycle chosen to be short enough that it is barely noticeable by the user, and therefore does not impact the user experience and timing of the desired inhaling.

In terms of relative ratio between the first heating power and second heating power, the first heating power can also be in the range of 20%-80% of reduction relative to the second heating power, as long as the evaporation of liquid 15, 115 occurs within the above-discussed duration of the HGGF cycle, more preferably the range of 50%-80%, more preferably 60%-80%. As a non-limiting example, if power device 80 is a Li-Ion battery having an output voltage of 3.6V, and the voltage is controlled internally to a value of 3.3V, this voltage being applied during the NHC cycle by power device 60 to heating device 30, 130, and the coil resistance of heating device 30, 130 is between 1.5 Ohm and 2 Ohm, with the equation that electrical power being the voltage in square divided by the resistance, the second heating power can be between 5.445 W to 7.26 W, while the first heating power can be for example around 50% of that value, being between 2 W and 4 W. However, there are also aerosol generating device 100 with much higher heating powers, e.g. with nominal heating powers up to 200 W and more.

With lower resistive values of the coil for heating device 30, 130, for example at sub-ohm resistance, e.g. 0.8 Ohm, the power reduction between first power delivery and the second power delivery, can be more than the indicate value of 50% discussed above. For example, the nominal power with 3.3V could be about 13 Watts and the ramp up voltage would likely be within about 20% and 50% of this nominal power, i.e. between 2.7 Watts and 7.5 Watts. As another non-limiting example, if aerosol generating device 100 is a mod tank device providing up to about 200 Watts and having a sub-ohm resistance of heater coil at about 0.8 Ohms, and having a 12V power source making the nominal power delivery 180 Watts or more, presumably the ramp up power could conceivably be as low as 5% of the nominal power, i.e. lower than 10 Watts.

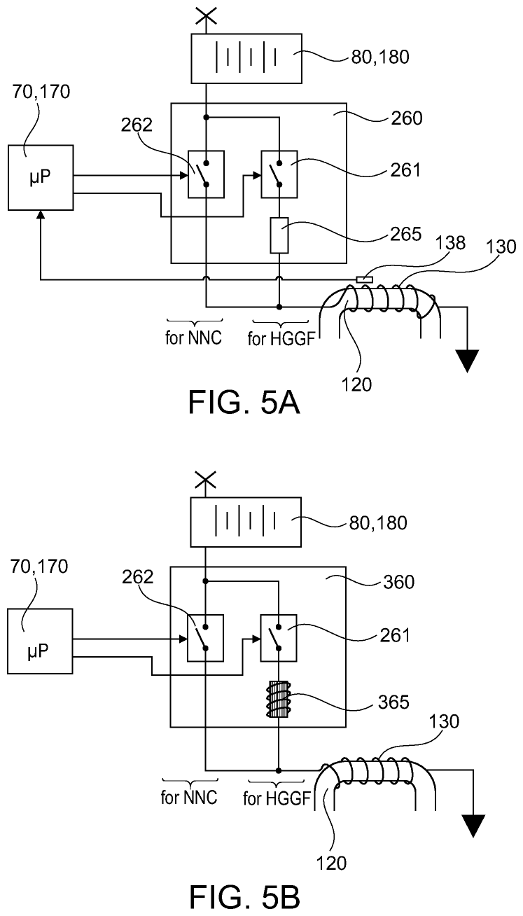

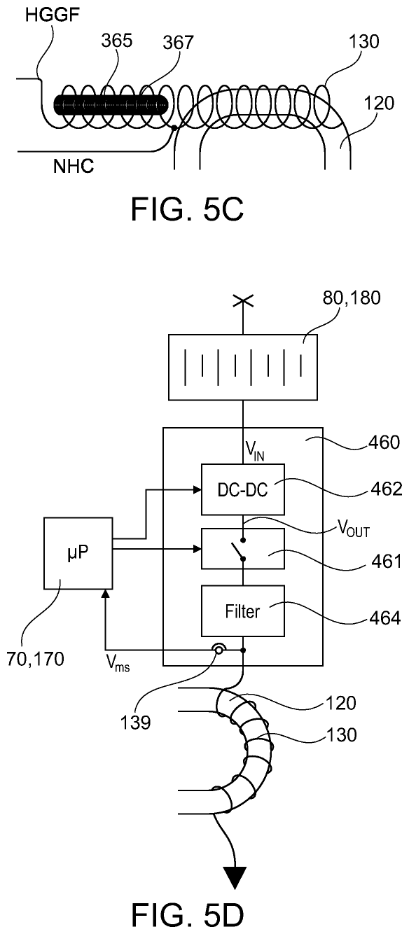

FIG. 5A shows an embodiment of the power control device 260 that is integrated or otherwise a part or inoperative connection with an aerosol generating device 100, to operate the heating device 30, 130 at the heater gas gap formation cycle HGGF and thereafter at the normal heating cycle NHC. A controller 70, 170, for example a microcontroller or other type of data processor, can control two switches 261, 262 that are arranged in parallel to provide for two different electric circuits that can deliver either the nominal power of the NHC via switch 262, or can deliver the reduced power as compared to the nominal power of the HGGF via switch 261. Specifically, voltage of power source 80, 180 and resistance value of the coil of heater device 130 are designed such, when switch 262 is in the on state and switch 261 is in the off state, controlled by controller 70, 170, the nominal power is delivered via switch 262 to heater 130 to provide for heating power in the NHC cycle. In turn, voltage of power source 80, 180 and resistance value of the coil of heater device 130 in addition with resistance value of resistor 265 are designed such, when switch 261 is in the on state and switch 262 is in the off state, controlled by microcontroller 70, 170, the reduced power is delivered to heater 130 to provide for the reduced heating power in the HGGF cycle.

This embodiment allows to make only minor variations to an existing heater 130 device, by adding an additional electric circuit or path to provide for the reduced power via an additional resistor 265. In idle mode, for example when the user is not inhaling or is not taking a puff, switches 261, 262 are controlled to be off by controller 70, 170, or are off by default. Then, when a user takes a puff or inhales, for example by detection with a puff sensor 174 or button 176, the HGGF cycle can be activated by putting switch 261 on, for example during a period of approximatively 100 ms to 300 ms, where the current is limited by the resistive value of resistor 265 and the resistive value of heater 130. Next, when the heater 130 has been heated enough, switch 261 is turned off, and switch 262 is turned on for nominal power operation with NHC cycle. It is also possible that switch 262 not operated in a steady on-state during the provision of the nominal heating power with the NHC cycle, but is switched with a pulse-width modulation pattern (“PWM”), controlled by controller 70, 170, for example with a temperature measurement feedback from temperature sensor 138, to stabilize the temperature by a control algorithm to perform a closed-loop temperature control, for example but not limited to a P, PI or PID control algorithm.

FIG. 5B shows another embodiment of the power control device 360 that is integrated or otherwise a part or inoperative connection with an aerosol generating device 100, to operate the heating device 30, 130 with the heater gas gap formation cycle HGGF and thereafter the normal heating cycle NHC. Similar to the embodiment of FIG. 5A, a microcontroller 70, 170 or other type of data processor can control two switches 261, 262 that are arranged in parallel to provide for two different electric circuits for providing the normal or nominal heating power for NHC via switch 262 or for providing reduced heating power of the HGGF via switch 261. Instead of a resistor or resistive element 265, an inductive element 365 is provided in the path or circuit of switch 261 for the HGGF. The indicative element 365 can also have a resistive component that allows to reduce the stationary HGGF cycle heating power. The inductive element 365 can have an inductance L that is configured to reduce an inrush current to avoid large current spikes that could cause the temperature to of heater device 30, 130 rise during the HGGF cycle, to cause the burn zone BZ.

FIG. 5C shows a variant where the inductive element 365 and the coil formed by the heating device 130 are combined to form a single coil, with inductive element 365 having a ferromagnetic inductor core 367 with the appropriate dimensions and coil winding number to provide for the desired inductance L, and at the same time coil of heating device 130 being wound around the fluidic element 120 as a wick. Between the inductive element 365 and the heater coil of heater device 130, an electric connection is made to connect to switch 262 for the normal heating cycle NHC heating power delivery. The combination of the inductive element 365 and the coil that forms heater device 130 can reduce device failure as it reduced the number of components, and can also provide for advantages of electromagnetic compatibility, as compared to the use of a separate inductive element. For example, a ferrite core for inductive element 365 can be placed within the wick 120, and the coil of heating element can be wound around wick 120 where the coil is located, so that coil forms the heating device 130 and the inductive element with the same components.

FIG. 5D shows another embodiment of the power control device 360 that is integrated or otherwise a part or inoperative connection with an aerosol generating device 100, to operate the heating device 30, 130 with the heater gas gap formation cycle HGGF and thereafter the normal heating cycle NHC, where a DC-DC converter 462 is used to control the heating power that is delivered to heating device 30, 130. For example, DC-DC converter 462 could be a boost generator with a controllable voltage output at Vout, having an input voltage Vin from the battery 80, 180, based on a setting that is provided by controller 70, 170. Therefore, only one circuit or path can be provided for heater gas gap formation cycle HGGF and normal heating cycle NHC, both heating powers given by a voltage output Vout of the DC-DC converter 462. Moreover, a power filter 464 can be optionally provided in the power or electric line that leads to heating device 30, 130, to filter out undesired voltage peaks or current peaks. For example, DC-DC converter 462 can be operated with PWM modulation, to have a small duty ratio during the period where the reduced power of the heater gas gap formation cycle HGGF is provided, for example but not limited to the range varying between 5% and 30%, and can have a larger duty ratio during the period where the nominal power of the normal heating cycle NHC is provided, for example but not limited to the range varying between 50% and 100%. A voltage sensor 139 can be arranged to measure the voltage at the heating device 130, or at the output of DC-DC converter 462 for closed-loop voltage control, which can be combined with a closed-loop temperature control.

The PWM control scheme can also be used for the embodiments in FIGS. 5A and 5B, performed by microcontroller 70, 170, so that the electric power that is delivered to heater 130 can be selectively controlled, and not only determined by resistor 265 or inductor 365.

For example, during the heater gas gap formation cycle HGGF, the Vout can be steadily increased to reach a desired temperature for the normal heating cycle NHC, where it can be certain that the gas gap GG has been formed. As explained above, the voltage ramp-up can be controlled by PWM modulation, or by the aid of characteristics of filter 464 that allows to filter the power delivered to heating device or heater 30, 130, for example a filter having mostly capacitive characteristics. Also, a switch 461 can be provided to cut any power delivery to heater 30, 130. In a variant, instead of having resistor 265 (FIG. 5A) or inductive element 365 (FIG. 5B), this part of the electric circuit could be equipped with the DC-DC converter 462 to provide for controllable and reduced power to the heating device 30, 130 in the heater gas gap formation cycle HGGF.

According to another aspect of the present invention, a cartridge, pod, or other type of consumable for holding and vaporizing the liquid 15, 115 is provided, having a memory 371 therein or otherwise associated therewith, for storing different parameters that characterize the cartridge 400 related to the heating, specifically parameters related to the control and performance the heater gas gap formation cycle HGGF, and this data can be sent from cartridge 400 to holder 500. A schematic and exemplary view of such cartridge 400 is shown in FIG. 6, being a cartridge 400 that can be a one-time use and disposable cartridge, a reusable or refillable cartridge, or an element that can be integrated or is an integral element of different types of aerosol generating devices. Cartridge 400 can be removably or fixedly connected to a holder 500, for example by a mechanical snap-on, clip-on, push-on, quick-release, threading, locking, bayonet mount connecting, complementary mating, press-fit connection, or other type of reversible attachment mechanisms, to form a complete aerosol generating system. In context of FIG. 6, the aerosol is generated from liquid 115 in cartridge 400 with heating device 130, and holder 500 includes a data processor or controller 170, power device 160 for controlling the electric power from battery 180, these elements previously described as elements integrated to aerosol generating device 200 of FIG. 2.

Holder 500 can have a longitudinal shape for being held by a user or operator for inhalation, and can have a power supply therein, for example a rechargeable battery 180. In the variant shown, cartridge 400 can include a casing 410, an inhalation channel 450 that can form a mouthpiece or can fluidically be connected to a mouthpiece, an aerosol generating chamber 455, a liquid containing chamber 115, for example a fixedly sealed or refillable one via a refilling port, a fluidic element 120 such as a wick, forming a fluidic pathway from liquid chamber or fluidic reservoir 411 to aerosol generating chamber 455, a heating device 130 for example a heating coil or other type of heating device in operative connection with wick 120, power cables 434 that are electrically connected to wick 120 at one end, and connected to electric terminals 412 at the other end, the terminals 412 arranged to connect with an external device, for example to power device 160 of holder 500. Terminals 412 and power cables 434 are configured to be fed with electrical power from an external device, for example holder 500, for example via corresponding terminals 512 that are in electric contact with a power device 160. Terminals 512 are arranged to be in electric contact with terminals 412 of cartridge 400 when holder 500 is connected to cartridge. In a variant, only two terminals 412, 512 are present, with no need for additional terminals 413, 513, to minimize the number of electric connections, and the controller 470 is configured to modulate the data of the parameters onto the power cables or wires 434, and controller 170 is configured to demodulate the data of the parameters at holder 500, to control power device 160.

Moreover, cartridge 400 can further include a data processing device 470, for example but not limited to a microcontroller, microprocessor, or other type of device that can access data from a memory 471 and send this data to an external device, for example holder 500, and memory 471, for example non-volatile memory or permanent memory for storing parameters related to the specific ramp-up heating, for example data related to the heater gas gap formation cycle HGGF.

In this respect, the cartridge 400 can be referred to as a smart or intelligent cartridge. This data includes the parameters that allows to perform the first power delivery from holder 500 to cartridge 400, but also can include data to perform the second power delivery from holder 500 to cartridge 400. Memory 471 can also be internal memory to data processing device 470. Data processing device 470 is operatively connected with terminals 413 that are arranged to connect or otherwise communicate with an external device, for example via corresponding terminals 513 of holder 500, that are in communicative connection with a controller 170 of holder 500, to exchange data when cartridge 400 is connected to holder 500. In a variant, cartridge 400 is equipped with a wireless communication port, and can communicate via wireless communication port to holder 500, to transmit data related to the parameters stored in memory 471.

With respect to the data of parameters that can be stored in memory 471, the data can represent the parameters required to properly perform the HGGF with a configuration given by the specific cartridge 400, and its heating and fluidic device 130, 120. For example this data can include but is not limited to data that represents the duration of the HGGF cycle for the given cartridge 400, data that represents the threshold idle time, data that represents the power supply level of the HGGF cycle, for performing the first power delivery by holder 500 to cartridge, and data that represents the power supply level during the NHC cycle, for performing the second power delivery. Generally, the parameters that characterize the HGGF cycle, where the first power delivery is performed, and also the NHC cycle, where the second power delivery is performed, strongly depend on the configuration of the heating device 130, for example the geometry of heating coil, including wire cross-sectional area, inductance of coil, number of windings, surface area formed by a winding, overall length of wire forming coil, and can also depend on the type of fluidic device 120 of cartridge 400, for example the type of wick, for example but not limited to a length of wick 120, length or dimensions of the transformation area TA, characteristics of the porosity or microchannels.

Therefore, these parameters are highly dependent on properties and arrangement of heating device 130 and fluidic device 120 and their arrangement with cartridge 400, and different types of cartridges 400 may be removably or fixedly mated with holder 500, to form an aerosol generating system 500. For this reason, preferably, data of these parameters are stored within memory 471 of cartridge 400 itself, and upon connection of cartridge 400 with holder 500, this data can be communicated or otherwise transmitted or made available to holder 500, for example for controlling power controller 160 to selectively generate the HGGF cycle in cartridge 400. The system with cartridge 400 and holder 500 of FIG. 6 is only exemplary, and the data of the parameters can be incorporated in different types of liquid cartridges that are equipped with a data processing device and memory, for example the one described in U.S. Patent Publication No. 2017/0035115, this reference herewith incorporated by reference in its entirety.

For example, memory 471 can store data that indicates or is representative of a resistance of heating element 130 that is present in cartridge 400, so that power delivery calculations as discussed supra can be done by holder 500 by controller 170 and power device 160 accordingly. Other data that can be stored is data that is representative or otherwise indicative of a power ratio between first power delivery and second power delivery cycles, data that includes information on the identification of the heating element 130 and its design parameters, including but not limited to diameter, length, volume, average cross-sectional area, porosity of heating element 130. Basically, memory 471 can store data that allows to characterize the cartridge 400 and its elements for properly generating the HGGF and NHC cycles for the specific parameters. This can allow holder 50 to read data or otherwise receive data from cartridge 400 via terminals 413, 513, or alternatively by a wireless connection, such that the HGGF and NHC cycles can be readily calculated or generated by controller 170 and power device 160, powering the heating device 130.

FIG. 7 shows two curves showing a timely evolution of a temperature of the heating device 30, 130 with the upper curve, and a heating power that is applied to heating device 30, 130 with the lower curve, to show a relationship between the power level of heating device and the temperature. For simplification and illustration purposes, the temperature is shown with straight lines, but in reality, the temperature curve would not have fully linear sections as shown.

During the time of 0−T₁, for example a duration of 50 ms, battery 80 can provide a first power delivery P1 to the heater 30, 130 controlled by power device 60 and in this case heating elements of the heater 30, 130 heat up relatively slowly, until we are relatively confident that a gas gap GG has been formed after which the power delivery is increased to the second power delivery P2. This phase (when the first power delivery P1 is provided) is referred to as the HGGF cycle. Prior to the point to increase power delivery from P1 to P2, there is a period during which vaporization starts occurring. This period straddles a temperature range able to vaporize chemical liquids within liquid 15, and such vaporization period is when the gas gap GG is formed. The vaporization temperature is a range because some chemical content has lower boiling temperature whilst others can have higher boiling temperature and because vaporization is a gradual process which starts a little below the boiling point in any event according to the laws of statistical thermodynamics. After the gas gap GG is formed (i.e., after the gas gap formation cycle HGGF has passed), power from battery 80 is controlled to increase the power to the heater 30, 130 with a second power delivery P2, and at that point the temperature of heater will ramp up rapidly towards target temperature for steady state operation and then will stabilize at a nominal power delivery which is typically about 80% of the max power applied for the final ramp up section, during the NHC cycle. In reality, power delivered to heater 30, 130 will typically reduce and then fluctuate up and down a bit once the heater has reached the target temperature as the feedback loop control kicks in to maintain the heater at the target temperature. Such feedback loop control method can be either classic control methods (e.g., PID, PI), or other advanced techniques to control temperature of heater. However, this part is not illustrated in FIG. 7 for simplification purposes, and a dashed line at the tail of the power line is shown for illustration purposes. Therefore, fluctuations and actual shape of the temperature graph of FIG. 7 are not fully represented and simplified for illustration purposes.

In sum, according to some aspects and some embodiments of the present invention, an initial ramp up power delivery profile referred to as HGGF can be performed when a user initiates heating, for example but not limited to the taking of a puff and activating a puff sensor which causes initiation of heating of the heater, or by the user pressing a “vape button” to similarly initiate heating of the heating element, which is lower than the power applied to the heater element during a steady state operation of the heater (e.g. during the majority of a user puff, which exemplarily can last about two (2) seconds but may be longer or shorter depending on the user, and the user's particular mood and/or circumstances at the time of taking the puff, etc., herein referred to as the NHC).

By employing such a reduced power ramp up phase the formation of undesirable chemicals (which are not typically present in the e-liquid prior to its vaporization but are rather most likely generated by means of an endothermic chemical reaction occurring during the heating of the e-liquid) may be mitigated because it is believed that these are predominantly formed outside of the steady state in which vaporization is occurring during the majority of a heating period (i.e. while a user is taking a “puff”); in particular, it is believed that such chemicals are predominantly formed during the initial heating up phase prior to the heating element reaching a temperature at which a “gas gap” is formed (once a gas gap has been formed, and provided the heating element maintains a sufficiently high temperature to maintain such a gas gap, no e-liquid directly touches the heating element because it vaporizes before it can touch the heating element).

Most likely, prior to a gas gap GG being formed, some of the molecules of the e-liquid may be more tightly bound to the heating element (which is typically formed of metal) than in a dynamic state where the liquid is flowing over the heating element or is separated from the heating element by a gas gap (for essentially similar reasons as to why static friction is typically greater than dynamic friction). In such a situation it is believed that a small number of molecules may reach a sufficiently high temperature (before vaporizing and evaporating away from the surface of the heating element) that instead of simply vaporizing into a gas form, they instead combine with neighboring molecules by means of a chemical reaction to form more complex chemicals (e.g. aldehydes) which may have an undesirable taste impact on the inhalation aerosol generated. Additionally, such chemicals may bind even more tightly to the metal heating element resulting in the additional problems noted above of deposits building up on the surface of the heating element over time after repeated inhalations.

By providing a reduced power during the formation of the gas gap, it is believed that more time is available for any e-liquid molecules adhering to the heating element to evaporate without having been chemically modified, before a sufficient temperature is reached by the molecules to enable them to undergo a chemical reaction so as to form a more complex, and organoleptically less desirable, chemical.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. An aerosol generating device comprising:
a fluidic pathway that is in fluidic connection with a container holding an aerosol-forming liquid;
a heating element that is in operative connection with the fluidic pathway, the heating element configured to heat the aerosol-forming liquid when inside the fluidic pathway to generate an aerosol;
a power device for controlling power delivered to the heating element to control a heating power of the heating element; and
a controller for controlling the power device to selectively make a first power delivery to the heating element to vaporize a portion of the aerosol-forming liquid to form a gas gap before making a second power delivery to the heating element, wherein the gas gap comprises an area of the fluidic pathway in contact with a heating surface of the heating element in which the aerosol-forming liquid has vaporised to form a gas;
wherein the first power delivery is at a value below the second power delivery.

2. The aerosol generating device of claim 1, wherein the controller is configured to make the first power delivery at a beginning of an inhalation period by the user during a heater gas gap formation HGGF cycle, and after the HGGF cycle the controller is configured to make the second power delivery for a remaining time of the inhalation period.

3. The aerosol generating device of claim 2, wherein the HGGF cycle has a duration below 500 ms, or below 300 ms, or below 150 ms.

4. The aerosol generating device of claim 1, wherein the power device includes a power switch configured to selectively make the power delivery to the heating element.

5. The aerosol generating device of claim 1, wherein the power device includes a DC-DC converter to control a voltage that is delivered to the heating element.

6. The aerosol generating device of claim 2, wherein after the inhalation period, the controller determines whether a wait period for a next inhalation period has revolved, and based on the determination the controller makes the first power delivery at a beginning of the next inhalation period or the second power delivery without making the first power delivery.

7. A method for controlling a power supply for an aerosol generating device, wherein the aerosol generating device comprise a container, a fluidic pathway, a heating element in operative connection with the fluidic pathway, and a power device, the method comprising the steps of:
detecting user inhalation of the aerosol generating device to determine an occurrence of an inhalation period;
determining a power profile to be delivered to the heating element from the power device during the inhalation period, wherein the power profile defines selection of a first power delivery to the heating element to vaporize a portion of the aerosol-forming liquid to form a gas gap before a second power delivery to the heating element, wherein the gas gap comprises an area of the fluidic pathway in contact with a heating surface of the heating element in which the aerosol-forming liquid has vaporised to form a gas, and wherein the first power delivery is at a value below the second power delivery; and
controlling the power device to make power delivery to the heating element based on the determined power profile.

8. The method for controlling a power supply of claim 7, wherein the first power delivery is performed at a beginning of the inhalation period during a heater gas gap formation (HGGF) cycle, and thereafter the second power delivery is performed for a remaining time of the inhalation period.

9. The method for controlling a power supply of claim 8, wherein the HGGF cycle has a duration below 500 ms, or below 300 ms, or below 150 ms.

10. The method for controlling a power supply of claim 7, further comprising a step of:
determining by a controller whether a wait period for a next inhalation period has revolved, and if the wait period has revolved, performing the first power delivery at a beginning of the next inhalation period.

11. The method for controlling a power supply of claim 7, further comprising a step of:
determining by a controller whether a wait period for a next inhalation period has revolved, and if the wait period has not revolved, performing the second power delivery at a beginning of the next inhalation period.

12. A cartridge for generating an aerosol, comprising:
a liquid container for holding an aerosol-forming liquid;
a fluidic pathway that is in fluidic connection with the liquid container;
a heating element that is in operative connection with the fluidic pathway, the heating element configured to heat the aerosol-forming liquid when inside the fluidic pathway to generate an aerosol;
a memory storing data related to a power profile needed by the heating element to generate the aerosol, wherein the power profile defines selection of a first power delivery to the heating element to vaporize a portion of the aerosol-forming liquid to form a gas gap before a second power delivery to the heating element, wherein the gas gap comprises an area of the fluidic pathway in contact with a heating surface of the heating element in which the aerosol-forming liquid has vaporised to form a gas, and wherein the first power delivery is at a value below the second power delivery; and
a controller for sending the data related to the power profile to an external device upon connection of the cartridge with the external device so that the external device can deliver power to the heating element of the cartridge based on the power profile.

13. The cartridge for generating an aerosol according to claim 12, further comprising:
first terminals arranged on the cartridge, the terminals configured to provide for an electric connection with the holder to receive electric energy of the first power delivery.

14. The cartridge for generating an aerosol according to claim 12, further comprising:
second terminals arranged on the cartridge, the terminals configured to provide the data to the holder.

15. The cartridge for generating an aerosol according to claim 12, wherein the memory further stores data related to a second power delivery that is performed at a remaining time of the inhalation period.
